(19) United States
(12) Patent Application Publication
(10) Pub. No.: US 2018/0203140 A1
(43) Pub. Date: Jul. 19, 2018

(54) METHODS AND SYSTEMS FOR ADAPTIVE SCATTER ESTIMATION

(71) Applicant: General Electric Company, Schenectady, NY (US)

(72) Inventors: Jun Miao, Pewaukee, WI (US); Steven Ross, Pewaukee, WI (US)

(21) Appl. No.: 15/409,343

(22) Filed: Jan. 18, 2017

(51) Int. Cl. G01T 1/29

(52) U.S. Cl. CPC G01T 1/2985

(57) ABSTRACT

Methods and systems are provided for scatter correction in Positron Emission Tomography (PET) imaging. In one embodiment, a method comprises performing an emission scan to acquire emission data, identifying outliers in a tail region of the emission data, discarding a portion of the outliers from the emission data, calculating a linear fit to remaining emission data in the tail region, and correcting the emission data based on the linear fit. In this way, scatter coincidence events can be eliminated even if the emission data is spatially misaligned with transmission data.

### FIELD

Embodiments of the subject matter disclosed herein relate to positron emission tomography (PET), and more particularly, to scatter correction for PET imaging.

### BACKGROUND

Multi-modality imaging systems exist that scan using different modalities, such as, for example, Positron Emission Tomography (PET), Single Photon Emission Computed Tomography (SPECT), and Computed Tomography (CT). During operation of a PET imaging system, for example, a patient is initially injected with a radiopharmaceutical that emits positrons as the radiopharmaceutical decays. The emitted positrons travel a relatively short distance before the positrons encounter an electron, at which point an annihilation occurs whereby the electron and positron are annihilated and converted into two gamma photons each having an energy of 511 keV.

The annihilation events are typically identified by a time coincidence between the detection of the two 511 keV gamma photons in the two oppositely disposed detectors, i.e., the gamma photon emissions are detected virtually simultaneously by each detector. When two oppositely disposed gamma photons each strike an oppositely disposed detector to produce a time coincidence, gamma photons also identify a line of response, or LOR, along which the annihilation event has occurred.

The number of time coincidences, generally referred to as coincidence events, detected within a field of view (FOV) of the detector is the count rate of the detector. The count rate at each of two oppositely disposed detectors is generally referred to as singles counts, or singles. The coincidence event is identified if the time difference between the arrivals of signals at the oppositely disposed detectors is less than a predetermined time coincidence. The number of coincidence events per second registered is commonly referred to as prompt coincidences or prompts. Prompts may include true, random, and scatter coincidence events.

True coincidences are those physically correlated time coincidences, i.e., two gamma photons emitted in the process of annihilation or photons produced from the two primary gamma photons. Random coincidences are events that arise from the essentially simultaneous detection of two photons that arise from two different annihilation events that occur at nearly the same time. Scatter coincidence events occur because some gamma rays are deflected from their original direction due to interaction with a body part before reaching the detectors. It is desirable to reject the scatter events during the acquisition of emission sinograms, because the images generated using only the detected true coincidence events represent a true activity distribution of radioactivity in the scanned body part of the patient. Moreover, scattered radiations increased the background to the image, thus degrading the image contrast.

One conventional method to correct for scatter includes identifying the counts just outside the boundary of the patient, where no true coincidence counts are expected. The outside counts contain both random and scatter events. After subtracting random counts, the scatter counts attributed to the 511 keV events are subtracted from the prompt counts across the field of view to give true coincidence counts.

However, this method relies on the accurate identification of the boundary of the patient, which is typically obtained from a CT image of the patient. Since PET and CT acquisitions occur sequentially, CT images and PET images may be misregistered or misaligned. Misregistration between the CT images and the PET images may occur due to data truncation in one of the modalities, or patient motion between the CT and the PET scans. As a result, some true coincidence events may be erroneously treated as scatter coincidence events, thereby resulting in an overestimation of scatter. In turn, artifacts may appear in the PET images after scatter correction. It is therefore desirable to increase the accuracy of scatter correction for instances of PET/CT image misalignment.

### BRIEF DESCRIPTION

In one embodiment, a method comprises performing an emission scan to acquire emission data, identifying outliers in a tail region of the emission data, discarding a portion of the outliers from the emission data, calculating a linear fit to remaining emission data in the tail region, and correcting the emission data based on the linear fit. In this way, scatter coincidence events can be eliminated even if the emission data is spatially misaligned with transmission or CT data.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a pictorial view of an exemplary multi-modal imaging system;

FIG. 2 shows a block schematic diagram illustrating an exemplary imaging system of a first modality;

FIG. 3 shows a high-level flow chart illustrating an example method for iterative scatter estimation according to an embodiment;

FIG. 4 shows a high-level flow chart illustrating an example method for adaptive outlier removal during iterative scatter correction according to an embodiment;

FIG. 5 shows a graph illustrating an example scatter plot and least-squares fitting according to an embodiment;

FIG. 6 illustrates an example spatial partitioning of a scatter image according to an embodiment; and

FIG. 7 shows a graph illustrating an updated least-squares fitting of a scatter plot according to an embodiment.

### DETAILED DESCRIPTION

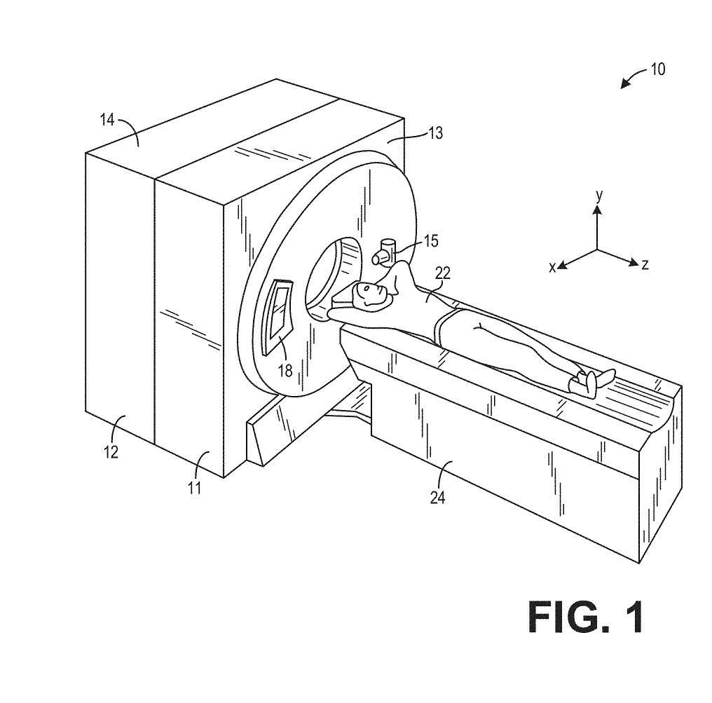

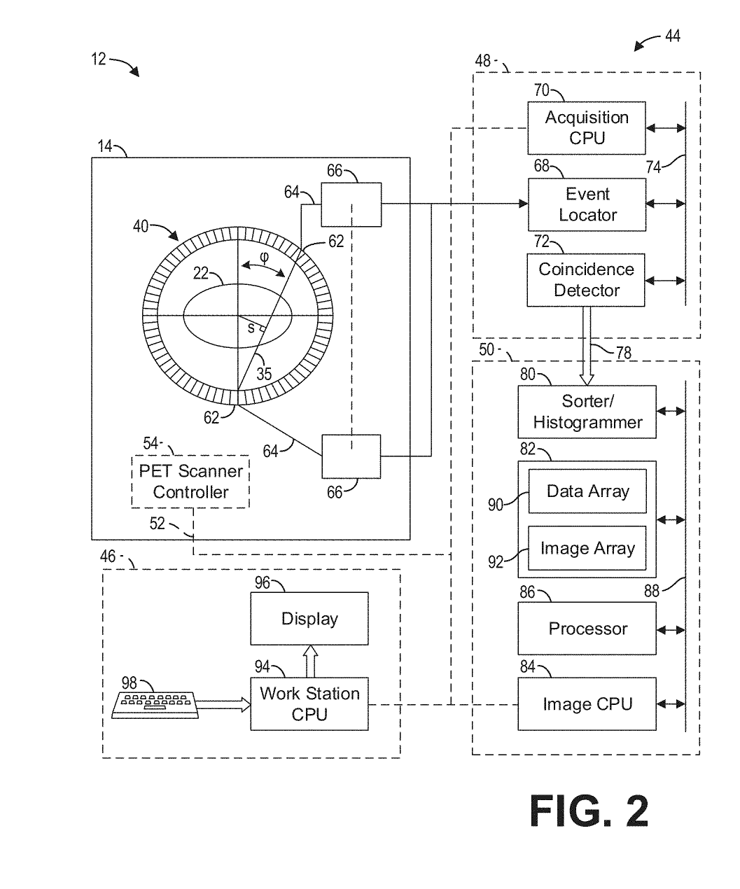

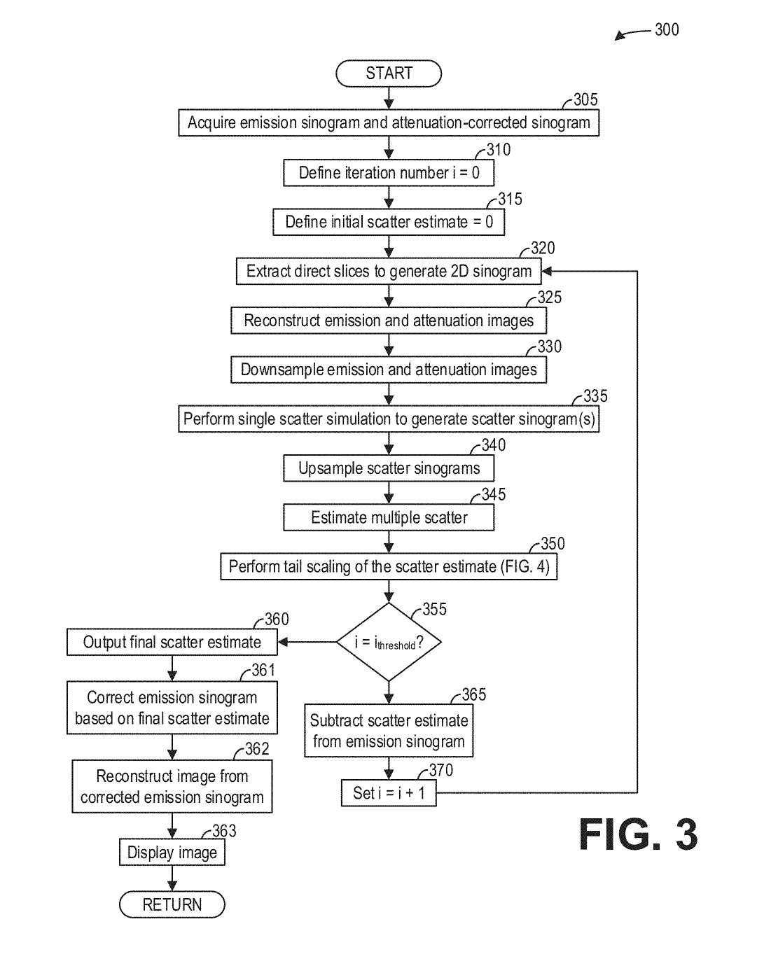

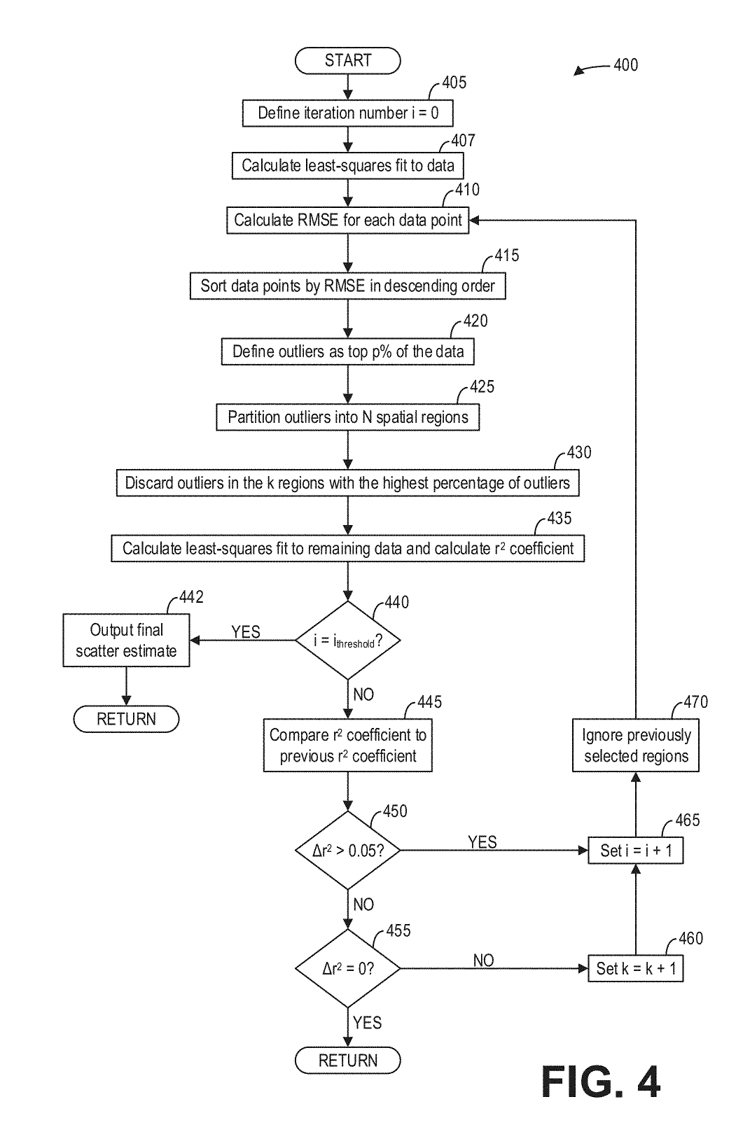

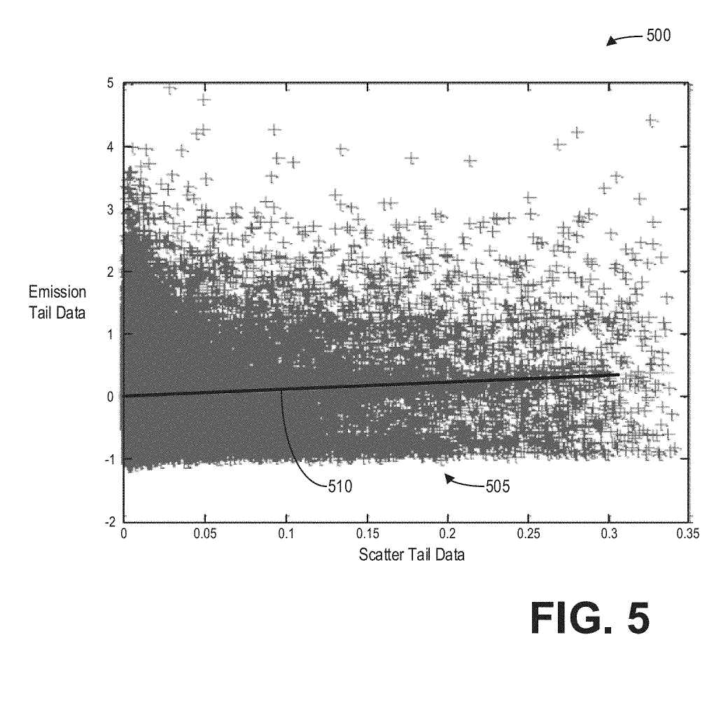

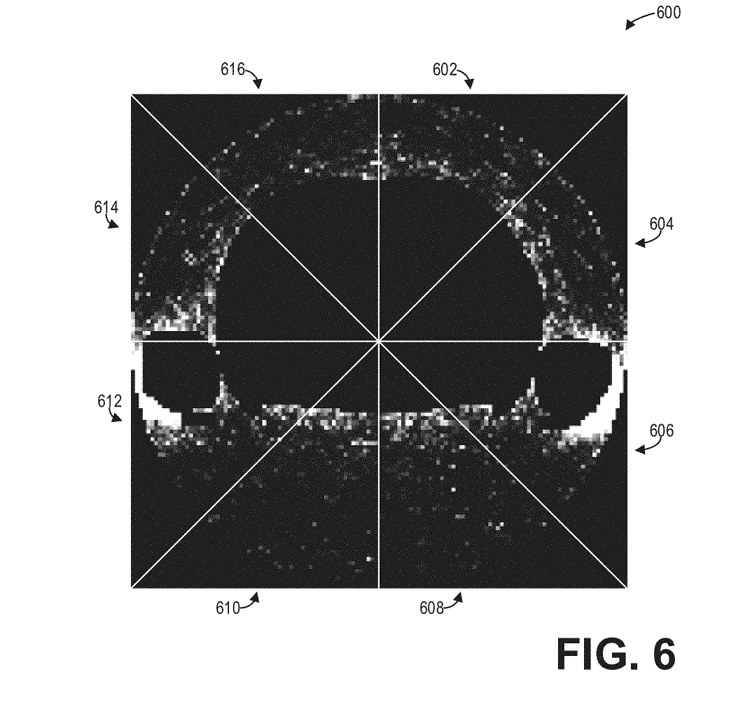

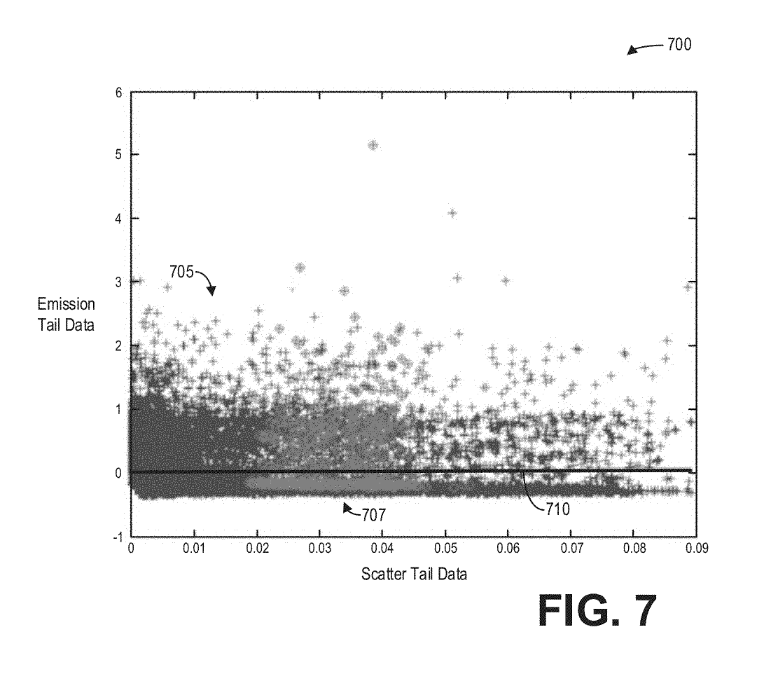

The following description relates to various embodiments of scatter correction for positron emission tomography (PET) imaging. In particular, systems and methods are provided for PET scatter tail fitting with adaptive iterative outlier removal. A multi-modality imaging system, such as the PET/CT system depicted in FIG. 1, may include an emission imaging system such as the PET imaging system depicted in FIG. 2. The image quality and quantitative accuracy of PET is impacted by a number of physical factors which must be accounted for during image reconstruction. One important factor is scatter correction, which is a vital component in the production of artifact-free, quantitative data. A method for scatter correction, such as the method depicted in FIG. 3, may comprise an iterative model-based scatter estimation. In such a method, given an emission sinogram and an attenuation-correction sinogram, emission images are reconstructed assuming initially that there are no scatters in the emission sinogram. With the attenuation map and the emission image, single scatters are estimated using model-based single scatter simulation (SSS) as known in the art. Multiple scatters are estimated by convolving the single scatter sinogram with an objected independent kernel. The total scatter is the sum of the single scatter and the multiple scatter estimates. There may be inaccuracies in the total scatter estimate because scatter from outside the current PET FOV may not be accounted for in the estimate. To account for this out-of-field scatter, the total scatter estimate is scaled by a factor based on activity outside the patient boundary which is known to come entirely from scattered events since there are no true sources outside the patient. The scatter scale factor is determined by least-square fitting the tail sections of the emission sinogram and the estimated scatter sinogram outside the patient boundary, where the boundary is generally determined from the CT image. These estimated scatters are then used as input for a next iteration or as the final scatter estimation at the last iteration. As discussed above, the robustness of the scatter scaling can be significantly impacted by errors between the estimate of the CT and PET patient boundary. A method for improving the process of least-square fitting the tail sections of the emission sinogram and the estimated sinogram, such as the method depicted in FIG. 4, improves the robustness to such errors. An example least-square fitting of the tail sections of the emission sinogram and the estimated scatter sinogram is shown in FIG. 5. Outliers may be determined based on the distance of data points in the tail sections to the least-squares fit. These outliers may then be partitioned into different spatial regions, as depicted in FIG. 6. As depicted in FIG. 7, the least-squares fit to the tail region is improved by removing at least a portion of the outliers from the data.

Though a PET/CT system is described by way of example, it should be understood that the present techniques may also be useful when applied to images acquired using other imaging modalities, such as tomosynthesis, MRI, C-arm angiography, and so forth. The present discussion of a PET/CT imaging modality is provided merely as an example of one suitable imaging modality.

As used herein, the phrase “reconstructing an image” is not intended to exclude embodiments of the present disclosure in which data representing an image is generated but a viewable image is not. Therefore, as used herein the term “image” broadly refers to both viewable images and data representing a viewable image. However, many embodiments generate, or are configured to generate, at least one viewable image.

Various embodiments of the present disclosure provide a multi-modality image system 10 as shown in FIGS. 1-2. Multi-modality imaging system 10 may be any type of imaging system, for example, different types of medical imaging systems, such as a Positron Emission Tomography (PET) imaging system, a Single Photon Emission Computed Tomography (SPECT) imaging system, a Computed Tomography (CT) imaging system, an ultrasound system, a Magnetic Resonance Imaging (MM) system, or any other system capable of generating tomographic images. The various embodiments are not limited to multi-modality medical imaging systems, but may be used on a single modality medical imaging system such as a stand-alone PET imaging system or a stand-alone SPECT imaging system, for example. Moreover, the various embodiments are not limited to medical imaging systems for imaging human subjects, but may include veterinary or non-medical systems for imaging non-human objects.

Referring to FIG. 1, the multi-modality imaging system 10 includes a first modality unit 11 and a second modality unit 12. The two modality units enable the multi-modality imaging system 10 to scan an object or patient in a second modality using the second modality unit 12. The multi-modality imaging system 10 allows for multiple scans in different modalities to facilitate an increased diagnostic capability over single modality systems. In one embodiment, multi-modality imaging system 10 is a Computed Tomography/Positron Emission Tomography (CT/PET) imaging system 10, e.g., the first modality 11 is a CT imaging system 11 and the second modality 12 is a PET imaging system 12. The CT/PET imaging system 10 is shown as including a gantry 13 representative of a CT imaging system and a gantry 14 that is associated with a PET imaging system. As discussed above, modalities other than CT and PET may be employed with the multi-modality imaging system 10.

The gantry 13 includes an x-ray source 15 that projects a beam of x-rays toward a detector array 18 on the opposite side of the gantry 13. Detector array 18 is formed by a plurality of detector rows (not shown) including a plurality of detector elements which together sense the projected x-rays that pass through a medical patient 22. Each detector element produces an electrical signal that represents the intensity of an impinging x-ray beam and hence allows estimation of the attenuation of the beam as it passes through the patient 22. During a scan to acquire x-ray projection data, gantry 13 and the components mounted thereon rotate about a center of rotation.

FIG. 2 is a block schematic diagram of the PET imaging system 12 illustrated in FIG. 1 in accordance with an embodiment of the present disclosure. The PET imaging system 12 includes a detector ring assembly 40 including a plurality of detector crystals. The PET imaging system 12 also includes a controller or processor 44, to control normalization, image reconstruction processes, and perform calibration. Controller 44 is coupled to an operator workstation 46. Controller 44 includes a data acquisition processor 48 and an image reconstruction processor 50, which are interconnected via a communication link 52. PET imaging system 12 acquires scan data and transmits the data to data acquisition processor 48. The scanning operation is controlled from the operator workstation 46. The data acquired by the data acquisition processor 48 is reconstructed using the image reconstruction processor 50.

The detector ring assembly 40 includes a central opening, in which an object or patient, such as patient 22 may be positioned using, for example, a motorized table 24 (shown in FIG. 1). The motorized table 24 is aligned with the central axis of detector ring assembly 40. This motorized table 24 moves the patient 22 into the central opening of detector ring assembly 40 in response to one or more commands received from the operator workstation 46. A PET scanner controller 54, also referred to as the PET gantry controller, is provided (e.g., mounted) within PET system 12. The PET scanner controller 54 responds to the commands received from the operator workstation 46 through the communication link 52. Therefore, the scanning operation is controlled from the operator workstation 46 through PET scanner controller 54.

During operation, when a photon collides with a crystal 62 on a detector ring 40, it produces a scintillation event on the crystal. Each photomultiplier tube or photosensor produces an analog signal that is transmitted on communication line 64 when a scintillation event occurs. A set of acquisition circuits 66 is provided to receive these analog signals. Acquisition circuits 66 produce digital signals indicating the three-dimensional (3D) location and total energy of the event. The acquisition circuits 66 also produce an event detection pulse, which indicates the time or moment the scintillation event occurred. These digital signals are transmitted through a communication link, for example, a cable, to an event locator circuit 68 in the data acquisition processor 48.

The data acquisition processor 48 includes the event locator circuit 68, an acquisition CPU 70, and a coincidence detector 72. The data acquisition processor 48 periodically samples the signals produced by the acquisition circuits 66. The acquisition CPU 70 controls communications on a back-plane bus 74 and on the communication link 52. The event locator circuit 68 processes the information regarding each valid event and provides a set of digital numbers or values indicative of the detected event. For example, this information indicates when the event took place and the position of the scintillation crystal 62 that detected the event. An event data packet is communicated to the coincidence detector 72 through the back-plane bus 74. The coincidence detector 72 receives the event data packets from the event locator circuit 68 and determines if any two of the detected events are in coincidence. Coincidence is determined by a number of factors. First, the time markers in each event data packet must be within a predetermined time period, for example, 12.5 nanoseconds, of each other. Second, the line-of-response (LOR) formed by a straight line joining the two detectors that detect the coincidence event should pass through the field of view in the PET imaging system 12. Events that cannot be paired are discarded. Coincident event pairs are located and recorded as a coincidence data packet that is communicated through a physical communication link 78 to a sorter/histogrammer 80 in the image reconstruction processor 50.

The image reconstruction processor 50 includes the sorter/histogrammer 80. During operation, sorter/histogrammer 80 generates a data structure known as a histogram. A histogram includes a large number of cells, where each cell corresponds to a unique pair of detector crystals in the PET scanner. Because a PET scanner typically includes thousands of detector crystals, the histogram typically includes millions of cells. Each cell of the histogram also stores a count value representing the number of coincidence events detected by the pair of detector crystals for that cell during the scan. At the end of the scan, the data in the histogram is used to reconstruct an image of the patient. The completed histogram containing all the data from the scan is commonly referred to as a “result histogram.” The term “histogrammer” generally refers to the components of the scanner, e.g., processor and memory, which carry out the function of creating the histogram.

The image reconstruction processor 50 also includes a memory module 82, an image CPU 84, an array processor 86, and a communication bus 88. During operation, the sorter/histogrammer 80 counts all events occurring along each projection ray and organizes the events into 3D data. This 3D data, or sinogram, is organized in one exemplary embodiment as a data array 90. Data array 90 is stored in the memory module 82. The communication bus 88 is linked to the communication link 52 through the image CPU 84. The image CPU 84 controls communication through communication bus 88. The array processor 86 receives data array 90 as an input and reconstructs images in the form of image array 92. Resulting image arrays 92 are then stored in memory module 82.

The images stored in the image array 92 are communicated by the image CPU 84 to the operator workstation 46. The operator workstation 46 includes a CPU 94, a display 96, and an input device 98. The CPU 94 connects to communication link 52 and receives inputs, e.g., user commands, from the input device 98. The input device 98 may be, for example, a keyboard, mouse, touch-screen panel, and/or a voice recognition system, and so on. Through input device 98 and associated control panel switches, the operator can control the operation of the PET imaging system 12 and the positioning of the patient 22 for a scan. Similarly, the operator can control the display of the resulting image on the display 96 and can perform image-enhancement functions using programs executed by the workstation CPU 94.

FIG. 3 shows a high-level flow chart illustrating an example method 300 for iterative model-based scatter estimation according to an embodiment. Method 300 is described herein with reference to the systems and components depicted in FIGS. 1 and 2, though it should be understood that the method may be implemented with other systems and components without departing from the scope of the present disclosure.

Method 300 begins at 305. At 305, method 300 acquires an emission sinogram and an attenuation-correction sinogram of a scan subject. A transmission sinogram or dataset is obtained by scanning the scan subject, such as patient 22, using the CT imaging system 11. Optionally, the transmission data may be obtained from a previous scan of the subject, wherein the transmission data has been stored in a memory device, such as memory device 82. The transmission sinogram may be corrected for attenuation to generate the attenuation-corrected transmission sinogram.

The emission sinogram or dataset is obtained using the second modality 12 (shown in FIG. 2). For example, the emission sinogram may be obtained by performing an emission scan of the subject to produce the emission sinogram. Optionally, the emission sinogram may be obtained from data collected during a previous scan of the subject, wherein the emission sinogram has been stored in a memory, such as memory device 82. In some examples, the emission sinogram and the transmission sinogram may be obtained during real-time. For example, the methods described herein may be performed on emission data as the emission data is received from the acquisition circuits 66 during a real-time examination of the subject 22.

Next, the method initializes the scatter correction. Specifically, at 310, method 300 defines an iteration number i equal to zero. At 315, method 300 defines an initial scatter estimate equal to zero.

Continuing at 320, method 300 extracts direct slices to generate 2D sinograms. Specifically, direct slices are extracted from the attenuation-corrected transmission sinogram and the emission sinogram. At 325, method 300 reconstructs emission and attenuation images from the 2D sinograms, for example, using filtered backprojection (FBP) or another suitable image reconstruction algorithm.

At 330, method 300 downsamples the emission and attenuation images. Downsampling the images reduces processing complexity for scatter correction. In some examples, the images may be axially downsampled to reduce the number of axial slices into a smaller number of axial composite planes or super-slices.

Continuing at 335, method 300 performs single scatter simulation to generate scatter sinogram(s). The method performs single scatter simulation based on the assumption that for the majority of scattered, detected events, only one of the two photons resulting from an annihilation undergoes a Compton interaction and this photon undergoes a single Compton interaction. The calculating of single scatters refers to the estimating of the contribution to the overall numbers of detected coincidence events of pairs of photons in which one of the photons has been scattered one time following the annihilation event. The single scatters for each sinogram are calculated using information provided by the sinogram and emission image dataset and the sinogram and image corresponding to the transmission dataset.

At 340, method 300 upsamples the scatter sinograms. Upsampling the scatter sinograms may include interpolating the sinogram back from the axially downsampled size to a normal size.

Although single scatters are the most common type of scatter, multiple scatters can also occur, in which both photons from an annihilation event are scattered once or more than once, or one of the photons from an annihilation event is scattered more than once. Consequently, at 345, method 300 estimates multiple scatters. More specifically, the method calculates multiple scatter contributions to the overall number of detected coincidence events. Typically, the multiple scatters are calculated at least in part based upon the single scatters calculated at 335. For example, to estimate multiple scatters, the method performs a convolution of the single scatter estimate generated at 335. The multiple scatter estimate is combined with or added to the single scatter estimate to obtain scatter sinograms including the single and multiple scatter estimates.

At 350, method 300 performs a tail scaling of the scatter estimate. The tail scaling operation sets the magnitude of the desired scatter correction by allowing calculation of the ratio of counts outside a given measured emission sinogram boundary to that in the scatter sinogram estimate. The scatter scale factor is determined by least-square fitting the tail sections of the emission sinogram and the estimated scatter sinogram outside the patient boundary, where the boundary is generally determined from the CT or transmission image.

It is assumed that counts emanating from outside the object are due to scatter. However, due to errors such as misregistration between the transmission sinogram and the emission sinogram, the boundaries of the object may not be sufficiently well-defined for the purpose of accurately identifying which counts emanate from outside the object. Such errors may arise from patient motion and CT image artifacts, as non-limiting examples. In cases where the boundary of the CT or transmission image does not match that of the PET or emission image, true PET source events may be treated as scatter events. This in turn causes the scatter estimate to be scaled to the true events rather than the scatter events, resulting in an overestimate of scatter which can lead to artifacts in the emission images. As described further herein with regard to FIG. 4, an improved method for least-square fitting the tail sections of the emission sinogram and the estimated scatter sinogram may include iteratively and adaptively identifying and discarding outliers in the tail data.

The full estimated scatter, including the single and multiple scatter estimates as well as the tail scaling, may be used as input for the next iteration of scatter correction or as the final scatter estimation at the last iteration. To that end, at 355, method 300 determines if the iteration number i is equal to an iteration number threshold i_{threshold} that defines the maximum number of iterations. If the iteration number i is equal to the iteration number threshold (“YES”), method 300 proceeds to 360. At 360, method 300 outputs the final scatter estimate. At 361, method 300 corrects the emission sinogram based on the final scatter estimate. At 362, method 300 reconstructs an image from the corrected emission sinogram. At 363, method 300 displays the image reconstructed at 362 via, for example, a display device such as display 96. Method 300 then returns.

If the iteration number i is not equal to the iteration number threshold (“NO”), method 300 proceeds to 365. At 365, method 300 subtracts the scaled scatter estimate from the emission sinogram. Continuing at 370, method 300 increases the iteration number by setting the iteration number i=i+1. Method 300 then returns to 320 to perform the next iteration.

FIG. 4 shows a high-level flow chart illustrating an example method 400 for adaptive outlier removal during iterative scatter correction according to an embodiment. Method 400 may be applied to each direct slice 2D sinogram during each scatter estimating iteration described hereinabove with regard to FIG. 3. Method 400 may thus comprise a subroutine of method 300. Method 400 is described herein with reference to the systems and components depicted in FIGS. 1 and 2, though it should be understood that the method may be implemented with other systems and components without departing from the scope of the present disclosure.

Method 400 begins at 405. At 405, method 400 defines an iteration number i=0. At 407, method 400 calculates a least-square fit to the data. Specifically, a linear least-squares fit algorithm may be applied to the emission data in the tail region. As an illustrative example, FIG. 5 shows a graph 500 illustrating an example plot of measured emission data in the tail region versus estimated scatter data, hereinafter referred to as scatter data points 505. The linear least-squares fit 510 is obtained based on the scatter data points 505.

At 410, method 400 calculates the root mean square error (RMSE) for each data point from all angles. Continuing at 415, method 400 sorts the data points by RMSE in descending order. At 420, method 400 defines outliers as the top p % of the data, where p may comprise a value ranging from 0.1 to 5. For example, p may be defined as 1, such that the outliers are defined as the top 1% of the data points.

At 425, method 400 partitions the outliers into N spatial regions. As an illustrative example, FIG. 6 illustrates an example spatial partitioning of a scatter image 600 into eight spatial regions 602, 604, 606, 608, 610, 612, 614, and 616. In the depicted example, the scatter image is partitioned into eight spatial regions, such that N equals eight. However, it should be appreciated that a number N of spatial regions other than eight may be utilized without departing from the scope of the present disclosure.

Referring again to FIG. 4, after spatially partitioning the outliers, method 400 continues to 430. At 430, method 400 discards the outliers in the k regions with the highest percentage of outliers. The parameter k determines the number of regions whose outliers are discarded during each iteration. Initially, k may be defined as two, such that the outliers in the two regions with the highest percentage of outliers are discarded, though other values of k may be utilized without departing from the scope of the present disclosure. As an example, the regions 606 and 612 may include the highest percentage of outliers, and so the outliers in the regions 606 and 612 may be discarded.

Continuing at 435, method 400 calculates a linear least-squares fit to the remaining data and calculates the r² coefficient of the linear fit, also referred to herein as the coefficient of determination. In the example depicted in FIG. 6, with the regions 606 and 612 discarded, method 400 calculates a linear least-squares fit to the data located in the spatial regions 602, 604, 608, 610, 614, and 616.

At 440, method 400 determines if the iteration number i is equal to the iteration number threshold i_{threshold}. If the iteration number i is equal to the iteration number threshold (“YES”), method 400 proceeds to 442. At 442, method 400 outputs the final scatter estimate. Method 400 then returns.

However, if the iteration number is not equal to the iteration number threshold (“NO”), method 400 proceeds to 445. At 445, method 400 compares the r² coefficient calculated at 435 to the previous r² coefficient. During the first iteration, the previous r² coefficient may comprise the r² coefficient of the linear fit calculated at 407. During later iterations, the previous r² coefficient may comprise the r² coefficient calculated at 435 in the previous iteration.

As an illustrative example, FIG. 7 shows a graph 700 illustrating an updated least-squares fitting of a scatter plot. Specifically, the graph 700 illustrates the scatter data points 705 (depicted in the graph as plus signs) along with identified outliers 707 (depicted in the graph as circled plus signs). The linear fit 710 is calculated based on the data points 705 with the outliers 707 removed. The r² coefficient of the linear fit 710 may thus be compared to the r² coefficient of the previously calculated linear fit, such as linear fit 510.

At 450, method 400 determines if the change in r² or Δr^{e} is greater than a threshold. In the depicted example, the threshold change is defined as 0.05, though it should be appreciated that other thresholds may be selected without departing from the scope of the present disclosure. It should also be understood that selecting a threshold change other than 0.05 may affect the total number of iterations.

If the change in r² is greater than 0.05 (“YES”), then the adaptive outlier removal is improving the accuracy of the linear fit, and method 400 proceeds to 465. However, if the change in r² is not greater than 0.05 (“NO”), method 400 proceeds to 455.

At 455, method 400 determines if the change in r² is equal to zero. If the change in r² is equal to zero (“YES”), then the outlier removal is not improving the scatter estimation, and method 400 returns. In this way, the method repeats the outlier removal procedure until the accuracy of the linear fit stops improving.

However, if the change in r² is not equal to zero (“NO”), method 400 proceeds to 460. At 460, method 400 sets k=k+1. That is, the method increases the number of spatial regions that will be discarded in the next iteration. Method 400 then proceeds to 465. At 465, method 400 increases the iteration number by setting the iteration number i=i+1. Continuing at 470, method 400 ignores the previously selected regions while continuing the next iteration of the scatter correction. Method 400 returns to 410.

The total number of iterations for removing the outliers is dependent on the data. Both parameters k and N are predefined. Studies indicate that defining k=2 and N=8, where k denotes regions to discard outliers and N the total regions, is sufficient. However, a higher value for N may help the algorithm adapt to the local anatomy better, with the cost of increased computation time. An initial value of k=2 is selected due to the symmetry of body parts (e.g., two arms).

The outliers that are removed from the regression may be related to the data from the mismatch between the PET and CT images, as the tail in the PET data is typically defined by the boundaries of the CT image.

A technical effect of the disclosure is the iterative and adaptive removal of scatter coincidence events from emission data. Another technical effect of the disclosure is the reconstruction of an image with improved image quality due to the prevention of scatter artifacts.

In one embodiment, a method comprises: performing an emission scan to acquire emission data; identifying outliers in a tail region of the emission data; discarding a portion of the outliers from the emission data; calculating a linear fit to remaining emission data in the tail region; and correcting the emission data based on the linear fit.

In a first example of the method, identifying the outliers comprises calculating a root-mean-square error for each data point of a plurality of data points in the tail region, sorting the plurality of data points by the calculated root-mean-square errors in descending order, and defining the outliers as a top percentage of the sorted plurality of data points. In a second example of the method optionally including the first example, the method further comprises spatially partitioning the outliers into a plurality of regions, wherein discarding the portion of the outliers from the emission data comprises discarding outliers in a predetermined number of regions of the plurality of regions with a highest percentage of outliers. In a third example of the method optionally including one or more of the first and second examples, the method further comprises calculating an initial linear fit to the emission data prior to identifying the outliers, wherein the root-mean-square error is calculated based on the initial linear fit. In a fourth example of the method optionally including one or more of the first through third examples, the method further comprises: calculating a difference between a first coefficient of determination of the linear fit and an initial coefficient of determination of the initial linear fit; responsive to the difference greater than a threshold, performing a second iteration; and responsive to the difference less than the threshold, increasing the predetermined number of regions to be discarded and performing the second iteration. In a fifth example of the method optionally including one or more of the first through fourth examples, the method further comprises, during the second iteration: identifying a second set of outliers in the tail region based on the linear fit while excluding data in previously-discarded regions; discarding a portion of the second set of outliers from the emission data; calculating a second linear fit to remaining emission data; and correcting the emission data based on the second linear fit. In a sixth example of the method optionally including one or more of the first through fifth examples, correcting the emission data based on the linear fit comprises scaling a scatter estimate based on the linear fit, and subtracting the scaled scatter estimate from the emission data. In a seventh example of the method optionally including one or more of the first through sixth examples, the scatter estimate includes estimates of single scatter and multiple scatter based on the emission data. In an eighth example of the method optionally including one or more of the first through seventh examples, the method further comprises reconstructing an image based on the corrected emission data. In a ninth example of the method optionally including one or more of the first through eighth examples, the linear fit comprises an ordinary least-squares fit.

In another embodiment, a method comprises: acquiring emission data; iteratively updating a scatter correction by selectively discarding outliers in a tail region of the emission data during each iteration; correcting the emission data based on a final estimate of the scatter correction; and reconstructing an image from the corrected emission data.

In a first example of the method, iteratively updating the scatter correction by selectively discarding the outliers in the tail region of the emission data during each iteration comprises, during each iteration: calculating a root-mean-square error for each data point of a plurality of data points in the tail region based on a previously-calculated linear fit to the plurality of data points; sorting the plurality of data points based on the calculated root-mean-square errors in descending order; defining the outliers as a top percentage of the sorted plurality of data points; partitioning the plurality of data points into a plurality of spatial regions; discarding outliers in one or more spatial regions of the plurality of spatial regions containing a highest percentage of outliers; calculating a linear fit to the plurality of data points excluding the discarded outliers; and updating the scatter correction based on the linear fit. In a second example of the method optionally including the first example, during each iteration, the plurality of data points in the tail region excludes the outliers in the one or more spatial regions discarded in a previous iteration. In a third example of the method optionally including one or more of the first and second examples, the method further comprises, during each iteration: calculating a difference between a coefficient of determination of the linear fit and a coefficient of determination of the previously-calculated linear fit; initiating a subsequent iteration responsive to the difference above a threshold; and increasing a number of spatial regions to be discarded in a subsequent iteration responsive to the difference below the threshold. In a fourth example of the method optionally including one or more of the first through third examples, the method further comprises discontinuing iteratively updating the scatter correction and outputting the final estimate of the scatter correction responsive to the difference equal to zero.

In yet another embodiment, a system comprises: a detector array configured to acquire emission data during a scan of a subject; and a processor operationally coupled to the detector array and configured with executable instructions in non-transitory memory that when executed cause the processor to: control the detector array to perform the scan of the subject and acquire the emission data; iteratively update a scatter correction by selectively discarding outliers in a tail region of the emission data during each iteration; correct the emission data based on a final estimate of the scatter correction; and reconstruct an image from the corrected emission data.

In a first example of the system, iteratively updating the scatter correction by selectively discarding the outliers in the tail region of the emission data during each iteration comprises, during each iteration: calculating a root-mean-square error for each data point of a plurality of data points in the tail region based on a previously-calculated linear fit to the plurality of data points; sorting the plurality of data points based on the calculated root-mean-square errors in descending order; defining the outliers as a top percentage of the sorted plurality of data points; partitioning the plurality of data points into a plurality of spatial regions; discarding outliers in one or more spatial regions of the plurality of spatial regions containing a highest percentage of outliers; calculating a linear fit to the plurality of data points excluding the discarded outliers; and updating the scatter correction based on the linear fit. In a second example of the system optionally including the first example, the scatter correction includes an estimate of single scatter and an estimate of multiple scatter. In a third example of the system optionally including one or more of the first and second examples, the system further comprises an x-ray source that emits a beam of x-rays toward the subject, and a detector that receives the x-rays attenuated by the subject, wherein the processor is operationally coupled to the detector and is further configured with instructions in the non-transitory memory that when executed cause the processor to receive projection data from the detector corresponding to the received x-rays attenuated by the subject, wherein the estimate of the single scatter and the estimate of the multiple scatter is based at least partially on the received projection data. In a fourth example of the system optionally including one or more of the first through third examples, the system further comprises a display device communicatively coupled to the processor, wherein the processor is further configured with instructions in the non-transitory memory that when executed cause the processor to display the reconstructed image via the display device.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method, comprising:
performing an emission scan to acquire emission data;
identifying outliers in a tail region of the emission data;
discarding a portion of the outliers from the emission data;
calculating a linear fit to remaining emission data in the tail region; and
correcting the emission data based on the linear fit.

2. The method of claim 1, wherein identifying the outliers comprises calculating a root-mean-square error for each data point of a plurality of data points in the tail region, sorting the plurality of data points by the calculated root-mean-square errors in descending order, and defining the outliers as a top percentage of the sorted plurality of data points.

3. The method of claim 2, further comprising spatially partitioning the outliers into a plurality of regions, and wherein discarding the portion of the outliers from the emission data comprises discarding outliers in a predetermined number of regions of the plurality of regions with a highest percentage of outliers.

4. The method of claim 3, further comprising calculating an initial linear fit to the emission data prior to identifying the outliers, wherein the root-mean-square error is calculated based on the initial linear fit.

5. The method of claim 4, further comprising:
calculating a difference between a first coefficient of determination of the linear fit and an initial coefficient of determination of the initial linear fit;
responsive to the difference greater than a threshold, performing a second iteration; and
responsive to the difference less than the threshold, increasing the predetermined number of regions to be discarded and performing the second iteration.

6. The method of claim 3, further comprising, during the second iteration:
identifying a second set of outliers in the tail region based on the linear fit while excluding data in previously-discarded regions;
discarding a portion of the second set of outliers from the emission data;
calculating a second linear fit to remaining emission data; and
correcting the emission data based on the second linear fit.

7. The method of claim 1, wherein correcting the emission data based on the linear fit comprises scaling a scatter estimate based on the linear fit, and subtracting the scaled scatter estimate from the emission data.

8. The method of claim 7, wherein the scatter estimate includes estimates of single scatter and multiple scatter based on the emission data.

9. The method of claim 1, further comprising reconstructing an image based on the corrected emission data.

10. The method of claim 1, wherein the linear fit comprises an ordinary least-squares fit.

11. A method, comprising:
acquiring emission data;
iteratively updating a scatter correction by selectively discarding outliers in a tail region of the emission data during each iteration;
correcting the emission data based on a final estimate of the scatter correction; and
reconstructing an image from the corrected emission data.

12. The method of claim 11, wherein iteratively updating the scatter correction by selectively discarding the outliers in the tail region of the emission data during each iteration comprises, during each iteration:
calculating a root-mean-square error for each data point of a plurality of data points in the tail region based on a previously-calculated linear fit to the plurality of data points;
sorting the plurality of data points based on the calculated root-mean-square errors in descending order;
defining the outliers as a top percentage of the sorted plurality of data points;
partitioning the plurality of data points into a plurality of spatial regions;
discarding outliers in one or more spatial regions of the plurality of spatial regions containing a highest percentage of outliers;
calculating a linear fit to the plurality of data points excluding the discarded outliers; and
updating the scatter correction based on the linear fit.

13. The method of claim 12, wherein, during each iteration, the plurality of data points in the tail region excludes the outliers in the one or more spatial regions discarded in a previous iteration.

14. The method of claim 12, further comprising, during each iteration:
calculating a difference between a coefficient of determination of the linear fit and a coefficient of determination of the previously-calculated linear fit;
initiating a subsequent iteration responsive to the difference above a threshold; and
increasing a number of spatial regions to be discarded in a subsequent iteration responsive to the difference below the threshold.

15. The method of claim 14, further comprising discontinuing iteratively updating the scatter correction and outputting the final estimate of the scatter correction responsive to the difference equal to zero.

16. A system, comprising:
a detector array configured to acquire emission data during a scan of a subject; and
a processor operationally coupled to the detector array and configured with executable instructions in non-transitory memory that when executed cause the processor to:
control the detector array to perform the scan of the subject and acquire the emission data;
iteratively update a scatter correction by selectively discarding outliers in a tail region of the emission data during each iteration;
correct the emission data based on a final estimate of the scatter correction; and
reconstruct an image from the corrected emission data.

17. The system of claim 16, wherein iteratively updating the scatter correction by selectively discarding the outliers in the tail region of the emission data during each iteration comprises, during each iteration:
calculating a root-mean-square error for each data point of a plurality of data points in the tail region based on a previously-calculated linear fit to the plurality of data points;
sorting the plurality of data points based on the calculated root-mean-square errors in descending order;
defining the outliers as a top percentage of the sorted plurality of data points;
partitioning the plurality of data points into a plurality of spatial regions;
discarding outliers in one or more spatial regions of the plurality of spatial regions containing a highest percentage of outliers;
calculating a linear fit to the plurality of data points excluding the discarded outliers; and
updating the scatter correction based on the linear fit.

18. The system of claim 16, wherein the scatter correction includes an estimate of single scatter and an estimate of multiple scatter.

19. The system of claim 18, further comprising an x-ray source that emits a beam of x-rays toward the subject, and a detector that receives the x-rays attenuated by the subject, wherein the processor is operationally coupled to the detector and is further configured with instructions in the non-transitory memory that when executed cause the processor to receive projection data from the detector corresponding to the received x-rays attenuated by the subject, wherein the estimate of the single scatter and the estimate of the multiple scatter is based at least partially on the received projection data.

20. The system of claim 16, further comprising a display device communicatively coupled to the processor, and wherein the processor is further configured with instructions in the non-transitory memory that when executed cause the processor to display the reconstructed image via the display device.
